(19) United States
(12) Patent Application Publication
(10) Pub. No.: US 2002/0044226 A1
(43) Pub. Date: Apr. 18, 2002

(54) Television remote control systems and methods

(76) Inventor: Christopher P. Risi, Laguna Niguel, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/921,009

(22) Filed: Aug. 2, 2001

Related U.S. Application Data
(60) Provisional application No. 60/222,563, filed on Aug. 3, 2000.
(60) Provisional application No. 60/263,348, filed on Jan. 22, 2001.

(51) Int. Cl. H04N 5/44

(52) U.S. Cl. 348/734

(57) ABSTRACT

The present systems and methods provide remote control devices that include buttons that depict the logos of various entities.

### PRIORITY INFORMATION

This application relates to and claims priority from U.S. Provisional Application No. 60/222,563 filed Aug. 3, 2000 and U.S. Provisional Application No. 60/263,348 filed Jan. 22, 2001, both of which are hereby incorporated by reference.

### FIELD OF THE INVENTION

The systems and methods of the present invention relate generally to the field of television remote controls.

### DESCRIPTION OF THE RELATED ART

Existing television remote controls allow users to enter the number of the channel that corresponds to the television station they wish to view. The television stations and channel numbers may be listed in a television guide or on a chart provided by the local television or cable station.

One common problem with conventional approaches is that users do not always know the number of the channel they wish to view and in many cases may not recall the name of the network that sponsors the television station they wish to view.

Another common problem with conventional approaches is that some users with poor vision may have difficulty looking up a channel number in a television guide or a chart.

### SUMMARY OF THE INVENTION

The present systems and methods provide remote control devices that include buttons that depict the logos of various entities.

For purposes of summarizing the invention, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### BRIEF DESCRIPTION OF THE DRAWINGS

FIG. 1 illustrates an example television remote control with logo buttons.

FIG. 2 illustrates a flow chart of sample button program process.

FIG. 3 illustrates a high-level block diagram of the remote control system.

### DETAILED DESCRIPTION

Systems and methods which represent one embodiment and example application of the invention will now be described with reference to the drawings. Variations to the systems and methods which represent other embodiments will also be described. In one embodiment, the systems and methods are used to provide a television remote control with logo buttons.

For purposes of illustration, one embodiment will be described in the context of a television remote control. The inventor contemplates that the present invention is not limited by the type of control device used, and that a variety of control devices may be used, such as, for example, a radio remote control device, a stereo remote control device, an Internet remote control device, a telephone, a computer keyboard, a personal computing device, a cellular phone, and so forth. The figures and descriptions, however, relate to an embodiment of the invention wherein the remote control device is a television remote control.

It is recognized that in other embodiments, the systems and methods may be implemented using a variety of components. The systems and methods will now be described with reference to the drawings summarized above. The drawings, the associated descriptions, and the specific implementation described herein are provided to illustrate embodiments of the invention, and not to limit the scope of the invention. The scope of the invention is defined by the appended claims and their equivalents.

I. Remote Control With Logo Buttons

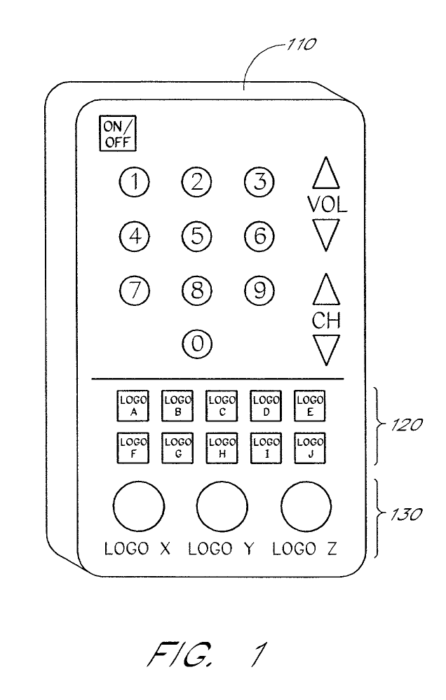

The present systems and methods provide a remote control that includes buttons that depict the logos or marks is illustrated in FIG. 1 of various entities. FIG. 1 illustrates a sample remote control 110 that includes buttons with logos using generic logos, such as, LOGO A, LOGO B, and so forth. In one embodiment, however, the remote control may include the CBS “eye” logo and/or the NBC “peacock” logo. The exemplary remote control also includes traditional buttons such as “ON/OFF,” Volume Control, Channel Up/Down, and numbered buttons to allow the user to enter the numeric designation of channels. The exemplary remote control also includes a set of preprogrammed buttons that depict logos 120 as well as a set of buttons that may be programmable by the user 130 and customized to reflect the networks selected by the user.

One benefit of having logos on or near the buttons is that users do not have to know the entities that correspond to the logos, but may identify the entities by their logos. In the television remote control example, a user would only need to recognize the logo without having to memorize the channel number of each station. Such benefit is useful not only to home users, but also to users who are away from home. For example, a user on travel in a different state may use the television remote control to watch videos on the Disney station. The user may locate the Disney logo on the television remote control and press the corresponding button without having to look up the channel number of the Disney station in his current location.

An additional benefit of one embodiment is that a remote control with logos is easier to use for users with poor vision and/or reading difficulties. For example, a user with vision problems may be able to recognize the CBS “eye” logo even though he may not be able to read the television guide, a channel chart, and/or the number buttons on the television remote control. In addition, children may be able to use the remote control. Parents may program buttons with the Disney logo, the Nickelodeon logo, the Cartoon channel logo, and so forth enabling a child to use the television remote control without having the ability to read and/or recognize station names or channel numbers.

As noted above, in one embodiment, the remote control 110 may include standard buttons 120 that have been preprogrammed. For example, a television remote control may include buttons with logos from popular networks, such as, for example, ABC, CBS, NBC, FOX, CNN, ESPN, VH1, and MTV. It is recognized, that a variety of standard buttons may be included and that the above listed networks are only meant to illustrate the feature of having standard buttons 120 and not to limit the scope of the invention. In one embodiment, the standard buttons 120 may be different for different audiences. For example, a children's television remote control may include standard buttons 120 with the Disney logo, the Nickelodeon logo, the Cartoon channel logo, and so forth. A television remote control for movie lovers may include standard buttons 120 with HBO, Cinemax, STAR, and Showtime. In addition, a hotel remote control may include ABC, CBS, NBC, FOX, CNN, ESPN, VH1, MTV, the Disney Channel, Nickelodeon, E!, and the Discovery Channel.

In one embodiment, the remote control 110 may also include user programmable buttons 130. This feature enables the user to program buttons and to add the logos of entities in which the user has an interest. For example, one user may program a television remote control to include buttons with logos from QVC, BET, and CMT, while another user may program in ESPN, Fox Sports West, ESPN2, Sci-Fi Channel, and The Golf Channel. It is recognized that a user may choose a variety of networks to add to the programmable buttons 130 and that the above listed combinations are meant to illustrate the feature of programmable buttons 130 and not to limit the scope of the invention. The television remote control 110 with logo buttons may include a set of various network logos that may be placed on the television remote control after the user has programmed the buttons. These logos may be permanent or may be removable. For example, in one embodiment the logos may be printed on permanent sticker material, removable sticker material, magnetic material, and so forth. In other embodiments, the television remote control may include a window behind which a logo may be displayed.

It is recognized that the remote control 110 may be implemented using a variety of different buttons with different logos. Further, in one embodiment, the remote control 110 with logo buttons may include both standard buttons 120 and programmable buttons 130. It is recognized that in other embodiments, the remote control 110 with logo buttons may only include programmable buttons 130 or may only include standard buttons 120. In other embodiments, the remote control 110 with logo buttons may also include once-only programmable buttons or limited access programmable buttons.

The programmable buttons 130 may be password protected such that only users who know the password may program and/or reprogram the programmable buttons 130. For example, if a television remote control 110 with logo buttons is used by a hotel, typically only the hotel management may be able to program the programmable buttons 130. The hotel guests may not be able to program the programmable buttons 130. In other embodiments, however, the hotel guests or certain hotel guests may be able to program one or more of the programmable buttons 130.

II. Button Program Process

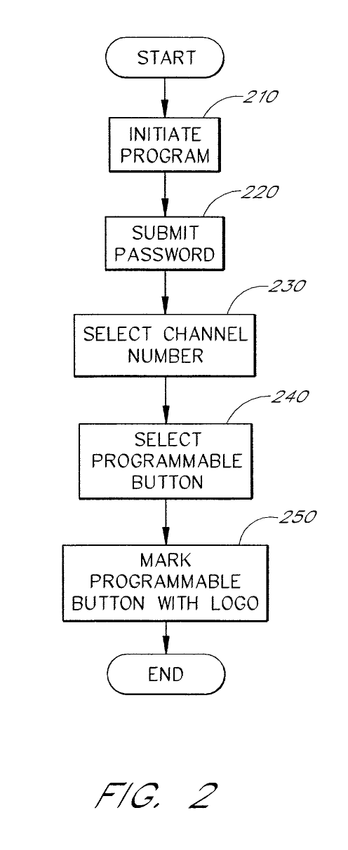

In one embodiment, the remote control 110 may include a button program as shown in FIG. 2. First, a user initiates the program process (block 210), such as, for example, by pressing a “program” button. Next, the user enters his password (block 220). For example, the user may submit a numeric password using the number keys and then press an “enter” button and/or a “password” button. The user then enters the channel number that corresponds to the station the user wishes to store (block 230) and then presses one of the programmable buttons (block 240). It is recognized that the television remote control 110 with logo buttons may include a “program” button, an “enter” button, and/or a “password” button. In other embodiments, the “program” button, “enter” button, and/or “password” button may be other buttons on the remote control (e.g., up channel, down channel, up volume, down volume, etc.). The user may then select a logo to place on the remote (block 250) to designate the newly programmed button. This may include, for example, placing a sticker depicting the logo on or near the button.

It is recognized that FIG. 2 illustrates one embodiment of a button program process and that other embodiments may be used. For example, the remote control 110 may include voice recognition technology in which the user speaks his password, channel selection, and/or programmable button selection. Further, the remote control 110 may include a touch screen for programming the programmable buttons 130. In addition, the remote control 110 may interface with another device, such as a computer, through which the remote control 110 receives instructions as to how to program the programmable buttons.

In one embodiment, the password may be included with the television remote control 110 with logo buttons and may also include change password instructions on the back of the remote control 110. In other embodiments, the password may be permanent, and/or the change instructions maybe offered as a supplemental instruction sheet, offered via phone instructions, include as a software program, provided by a “help module” and so forth.

III. Television Remote Control Styles

It is recognized that the remote control 110 illustrated in FIG. 1 illustrates one sample remote control. In other embodiments, the remote control may include other buttons, may include buttons of different shapes and/or sizes, may have the buttons located in different locations on the remote control, and so forth. Further, the remote control may be included as part of another device or unit. For example, the remote control may be embedded in a console in a couch, placed inside a steering wheel of a car, and so forth.

The remote control with logo buttons may be offered in a variety of styles. For example, it may be offered in multiple solid colors (e.g., black, gray, silver, red, pink, blue, etc.), in multiple color combinations (e.g., red/black, white/blue, etc.), in multiple patterns (e.g., leopard pattern, polka dots, etc.), in popular combinations (e.g., a UCLA remote with blue and gold, a USC remote with red and gold, a Laker remote with the Laker logo and in purple and yellow, etc.), or in a variety combinations of the above.

In addition, the remote control with logo buttons may be offered in a variety of sizes. For example, one television remote control with logo buttons may be offered in a small size for hotels with only programmable buttons 130 that may be programmed by management or preprogrammed. Another television remote control with logo buttons may be offered in a larger size for the general public with several standard buttons 120 (preprogrammed with the channel numbers) along with a few programmable buttons In addition, another television remote control with logo buttons may be offered in an extra large size with extra large logo buttons for those users that may have difficulty seeing smaller buttons. A variety of combinations may be used.

In one embodiment, the remote control with logo buttons may also include universal remote buttons for one or more devices, such as, for example, a television, a VCR, a stereo, a CD player, a computer, and so forth.

Appendix A provides a set of various remote control styles. Appendix B illustrates a sample chart of potential packages of television remote controls with logo buttons that may be offered for sale.

IV. Remote Control System

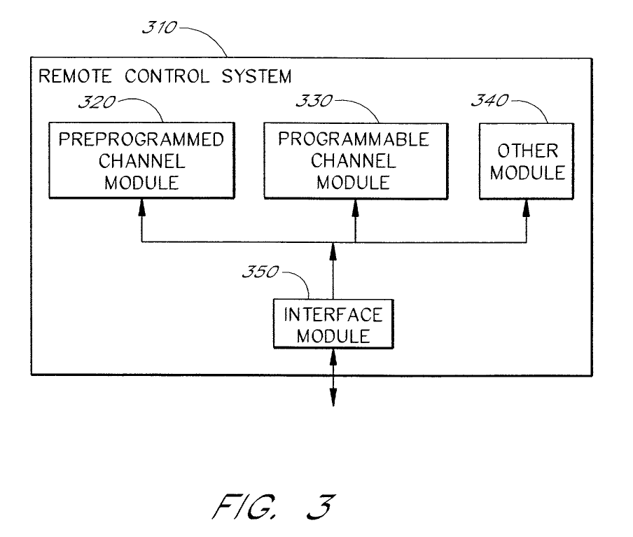

FIG. 3 illustrates a block diagram of one embodiment of a remote control system 210 which may be used to implement the features discussed above. Technology for controlling standard remote controls is well known in the art, however, FIG. 3 shows technology that may be used to implement various embodiments of the remote control with logo buttons.

The exemplary remote control system 310 includes a preprogrammed channel module 320, a programmable channel module 330, and an other module 340 that communicates with an interface module 350. The interface module 350 may interact with the hardware components, devices, and/or drivers that receive user input, such as, for example, the buttons, voice recognition modules, touch screen drivers, and so forth.

The preprogrammed channel module 320 determines how the remote control system 310 responds when a user selects a preprogrammed channel. For example, when a user selects the preprogrammed button with the NBC logo, the preprogrammed channel module 320 changes the television to show the channel that corresponds to the NBC station. In addition, the preprogrammed channel module 320 may interact with other components for setting the preprogrammed channels, such as, for example, a remote control programmer. For example, a hotel may use an external device to program the preprogrammed channels of multiple remote controls.

The programmable channel module 330 determines how the remote control system 310 responds when a user selects a programmable channel button. For example, when a user selects the programmed programmable button with the Golf Channel logo, the programmable channel module 330 changes the television to show the channel that corresponds to the Gold Channel station. In addition, the programmable channel module 330 may interact with other components for setting the programmable channels, receiving, and/or verifying password information, and so forth.

The other module 340 may be used to implement other parts of the remote control that are well known in the art, such as, for example, volume control, numeric button selections, channel up/down, and so forth.

The interface module 350 interacts with the hardware components, devices and/or drivers of the remote control to receive input from the user via the buttons, as well as other interface technology, such as voice recognition modules, touch screens, and so forth.

While the preprogrammed channel module 320, the programmable channel module 330, the other module 340, and the interface module 350 are illustrated as separate modules, it is recognized that one or more of the modules may be combined and/or one or more of the modules may be broken down into multiple modules.

Further, as used herein, the word module refers to logic embodied in hardware or firmware, or to a collection of software instructions, possibly having entry and exit points, written in a programming language, such as, for example, C++. A software module may be compiled and linked into an executable program, or installed in a dynamic link library, or may be written in an interpretive language such as BASIC. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as hardware modules, but may be represented in software.

V. Conclusion

As noted above, while many of the above examples reference a television remote control, the present invention is not limited by the type of control device used. Moreover, the types of control devices may include, for example, a radio remote control device with logo buttons (e.g., logos of radio stations, etc.), a stereo remote control device with logo buttons (e.g., logos of radio stations, favorite bands, favorite CDs, etc.), an Internet remote control device with logo buttons (e.g., logos of internet web sites, favorite search engine, companies with web sites, etc.), a telephone with logo buttons (e.g., logos of fast food delivery companies, service repair companies, utility companies, etc.), a computer keyboard with logo buttons (e.g., logos of internet web sites, service repair companies, etc.), a personal computing device with logo buttons (e.g., logos of internet web sites, service repair companies, favorite stock quote source, favorite search engines, etc.), a cellular phone with logo buttons (e.g., logos of restaurants, frequently called numbers, children's schools, car dealership, driving instruction company, AAA, etc.), and so forth, as well as any combination of one or more devices.

While certain embodiments of the invention have been described, these embodiments have been presented by way of example only and are not intended to limit the scope of the present invention. Accordingly, the breadth and scope of the present invention should be defined in accordance with the following claims and their equivalents.

[image]

[image]

[image]

[image]

[image]

[image]

[image]

[image]

[image]

What is claimed is:

1. A television remote control device comprising:
a plurality of station buttons programmed to select television stations, wherein said station buttons depict logos of said corresponding television stations.

2. The television remote control device of claim 1 wherein at least one of said plurality of station buttons are programmed by a user.

3. The television remote control device of claim 1 wherein at least one of said plurality of station buttons are pre-programmed.

4. A control device configured to access information such as sound, video, graphics or text, wherein said control device comprises:
at least one interface wherein said interface corresponds to at least one logo of a source of information.

5. The control device of claim 4 wherein said interface includes a button.

6. The control device of claim 4 wherein said interface includes a touch screen.

7. A method of providing a television remote control, wherein said method comprises:
providing a television remote control component configured to select channels on a corresponding television;
providing a set of pre-programmed buttons in conjunction with said television remote control component, wherein said set of pre-programmed buttons are programmed to select pre-selected channels; and
providing a set of user-programmable buttons in conjunction with said television remote control component, wherein said set of user-programmable buttons may be programmed by a user to select channels using a password.

8. A method of programming a television remote control with logo buttons and at least one programmable button, the method comprising:
initiating a programming program;
submitting a password;
submitting a numeric channel selection;
selecting one programmable button; and
marking the programmable button with a logo that corresponds to the numeric channel selection.
